(19) United States
(12) Patent Application Publication
(10) Pub. No.: US 2024/0246605 A1
(43) Pub. Date: Jul. 25, 2024

(54) CONTROL APPARATUS AND CONTROL METHOD

(71) Applicant: ISUZU MOTORS LIMITED, Yokohama-shi (JP)

(72) Inventors: Shuuichi YAHAGI, Fujisawa-shi (JP); Motoya SUZUKI, Fujisawa-shi (JP)

(21) Appl. No.: 18/414,616

(22) Filed: Jan. 17, 2024

(30) Foreign Application Priority Data
Jan. 19, 2023 (JP) 2023-006531

(51) Int. Cl. B62D 6/00

(52) U.S. Cl. CPC B62D 6/003

(57) ABSTRACT

A control apparatus for PI-controlling a control input value to a control object on the basis of a difference between a target value to the control object and an output value from the control object, the control apparatus includes an estimation part that estimates an amount of deviation in a control model, in which a differential of an output value of the control object including measurement noise is defined by the control input value and an amount of deviation of the output value of the control object from an output value of a normative model, by means of a Kalman filter composed of a state space model, a calculation part that obtains the control input value on the basis of the estimated amount of deviation, a proportional gain, and an integral gain, and an adjustment part that adjusts a parameter for setting a Kalman gain of the Kalman filter.

### CROSS-REFERENCE TO RELATED APPLICATIONS

The present application claims priority to Japanese Patent Applications number 2023-006531, filed on Jan. 19, 2023 contents of which are incorporated herein by reference in their entirety.

### BACKGROUND OF THE INVENTION

The present disclosure relates to a control apparatus and a control method for performing PI control.

A yaw rate control apparatus for controlling a yaw rate of a vehicle is known as a control apparatus that controls a control input value to a control object on the basis of a difference between a target value and an output value from the control object (see Japanese Unexamined Patent Application Publication No. 2010-126093). The yaw rate control apparatus controls a steering angle of a vehicle according to a difference between a target yaw rate and an actual yaw rate, for example.

In recent years, in order to suppress a deviation between a target value and an output value of a control object, a method has been proposed that uses PI control and that estimates a deviation amount of output from a control object, as specified in an Ultra-Local Model, to obtain a control input.

However, in the above method, output is differentiated when estimating an error, which may increase the influence of measurement noise, which is a disturbance in the output.

### BRIEF SUMMARY OF THE INVENTION

The present disclosure focuses on this point, and an object thereof is to compensate for a model error while suppressing the influence of measurement noise.

### Means for Solving the Problems

A first aspect of the present disclosure provides a control apparatus for PI-controlling a control input value to a control object on the basis of a difference between a target value to the control object and an output value from the control object, the control apparatus includes an estimation part that estimates an amount of deviation in a control model, in which a differential of an output value of the control object including measurement noise is defined by i) the control input value and ii) an amount of deviation of the output value of the control object from an output value of a normative model, by means of a Kalman filter composed of a state space model, a calculation part that obtains the control input value on the basis of the estimated amount of deviation, a proportional gain, and an integral gain, and an adjustment part that adjusts a parameter for setting a Kalman gain of the Kalman filter.

A second aspect of the present disclosure provides a control method, executed by a processor, for PI-controlling a control input value to a control object on the basis of a difference between a target value to the control object and an output value from the control object, the method includes the steps of estimating an amount of deviation in a control model, in which a differential of an output value of the control object including measurement noise is defined by i) the control input value and ii) a deviation amount of the output value of the control object from an output value of a normative model, by means of a Kalman filter composed of a state space model, obtaining the control input value on the basis of the estimated amount of deviation, a proportional gain, and an integral gain, and adjusting a parameter for setting a Kalman gain of the Kalman filter.

### BRIEF DESCRIPTION OF THE DRAWINGS

FIG. 1 illustrates an overview of a vehicle S according to the present embodiment.

FIG. 2 is a control block diagram illustrating an operation of determining a control input value.

FIG. 3 illustrates a flow of automatic adjustment of parameters Q and R.

### DETAILED DESCRIPTION OF THE INVENTION

Hereinafter, the present disclosure will be described through exemplary embodiments of the present disclosure, but the following exemplary embodiments do not limit the disclosure according to the claims, and not all of the combinations of features described in the exemplary embodiments are necessarily essential to the solution means of the disclosure.

### <Overview of Vehicle S>

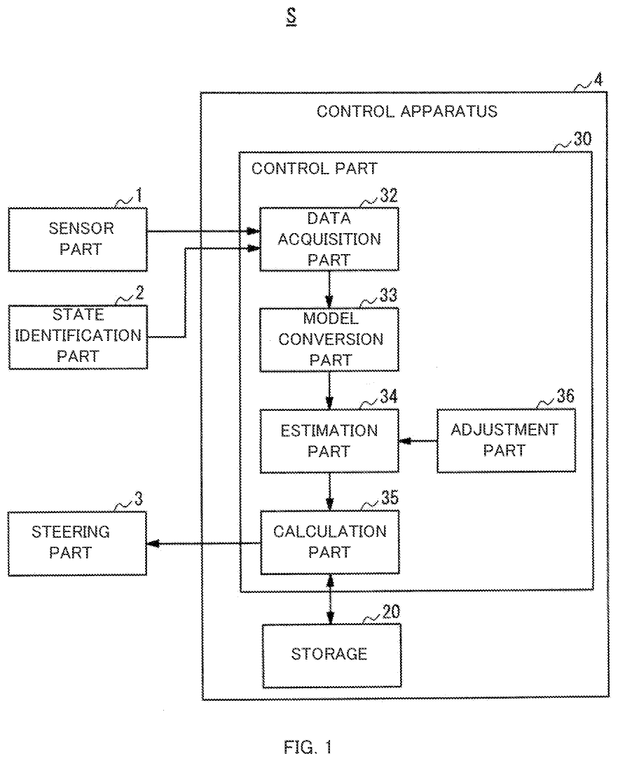

FIG. 1 illustrates an overview of a vehicle S according to the present embodiment. The vehicle S shown in FIG. 1 includes a sensor part 1, a state identification part 2, a steering part 3, and a control apparatus 4. The vehicle S has a function of calculating a steering angle for traveling along a set route and automatically steering the vehicle S while the vehicle S is turning.

The sensor part 1 includes, for example, a steering angle sensor and a yaw rate sensor, and detects a steering angle and a yaw rate of the vehicle S while the vehicle S is traveling.

The state identification part 2 includes i) a receiving device that receives radio waves, indicating a position of the vehicle S, from an external positioning system such as Global Navigation Satellite System (GNSS) and ii) an Inertial Measurement Unit (IMU) that includes an acceleration sensor and an angular rate sensor. The state identification part 2 identifies the target yaw rate for traveling along the set route using the receiving device and the IMU.

The state identification part 2 identifies a traveling direction of the vehicle S, for example, by identifying the position of the vehicle S at a plurality of times on the basis of the radio waves received by the receiving device. The state identification part 2 identifies the target yaw rate on the basis of i) a difference between a direction indicated by the set route and an identified traveling direction of the vehicle S and ii) a difference between a position in the set route and the position of the vehicle S.

The steering part 3 has a function of automatically steering the vehicle S. The steering part 3 rotates a steering shaft by means of a steering motor or the like on the basis of, for example, a steering angle inputted by the control apparatus 4, to turn the traveling vehicle S to the right or to the left.

The control apparatus 4 calculates the steering angle of the vehicle S while the vehicle S is turning, on the basis of i) the yaw rate of the vehicle S detected by the sensor part 1 and ii) the target yaw rate of the vehicle S identified by the state identification part 2. The control apparatus 4 controls the yaw rate of the vehicle S while the vehicle S is turning by causing the steering part 3 to automatically steer the vehicle S while the vehicle S is turning on the basis of the steering angle calculated at predetermined time intervals.

### <Detailed Configuration of Control Apparatus>

The control apparatus 4 performs PI control of a control input value to a control object on the basis of a difference between a target value to the control object and an output value from the control object. In the following, the steering part 3 is taken as an example of the control object, but the control object is not limited thereto, and may be another unit in the vehicle S.

The control apparatus 4 performs the PI control of the steering angle of the vehicle S, which is a control input, on the basis of the difference between the target yaw rate and an actual yaw rate of the vehicle. As shown in FIG. 1, the control apparatus 4 includes a storage 20 and a control part 30.

The storage 20 includes a Read Only Memory (ROM), which stores a Basic Input Output System (BIOS) and the like of the computer, and a Random Access Memory (RAM), which serves as a work area. Further, the storage 20 is a mass storage device such as a Hard Disk Drive (HDD) or a Solid State Drive (SSD) that stores an Operating System (OS), an application program and various types of information referred to when said application program is executed.

The control part 30 is a processor such as a Central Processing Unit (CPU) or a Graphics Processing Unit (GPU). The control part 30 functions as a data acquisition part 32, a model conversion part 33, an estimation part 34, a calculation part 35, and an adjustment part 36 by executing the program stored in the storage 20. It should be noted that the control part 30 may be formed of a single processor, or may be formed of a plurality of processors or a combination of one or more processors and an electronic circuit.

The data acquisition part 32 acquires the target yaw rate and the actual yaw rate. For example, the data acquisition part 32 acquires the target yaw rate identified by the state identification part 2. Further, the data acquisition part 32 acquires the actual yaw rate detected by the sensor part 1. The data acquisition part 32 can acquire the target yaw rate and the actual yaw rate at predetermined time intervals during traveling of the vehicle S.

The model conversion part 33 converts a control model of the control object into a state space model. Here, the control model includes measurement noise, which is a disturbance, and is a model where a differential of the output value of the steering part 3 is defined by i) the control input value and ii) an amount of deviation of the output value of the steering part 3 from an output value of a normative model. The normative model is a model designed to meet a desired response characteristic.

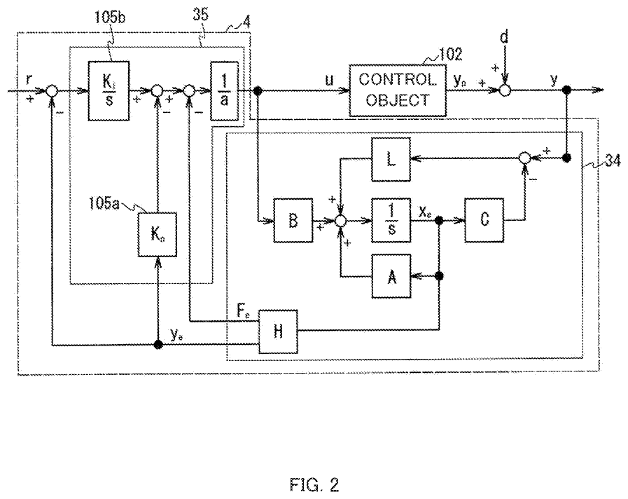

Here, the control model of the control object is described with reference to FIG. 2.

FIG. 2 is a control block diagram illustrating an operation of determining the control input value. In FIG. 2, a control object 102 is the steering part 3 of the vehicle S. A steering angle u, which is the control input, is inputted to the control object 102. Further, an actual yaw rate y is outputted as an output from the control object 102. The control apparatus 4 controls the steering angle u, which is the control input of the control object 102, on the basis of a deviation between a target yaw rate r, which is the target value, and the actual yaw rate y. The control apparatus 4 feedback-controls the steering angle u so that a deviation e between the target yaw rate r and the actual yaw rate y becomes zero. Furthermore, the control apparatus 4 includes a proportional device 105a and an integrator 105b to perform the PI control.

The control apparatus 4 uses a known Ultra-Local Model as the control model of the control object 102 to achieve a desired yaw rate response. The Ultra-Local Model is expressed as in Equation (1).

$$\dot{y} = au + F \qquad ( 1 )$$

In Equation (1), a is a design parameter, and F is an amount of deviation. A deviation amount F is the amount of deviation of the output value of the control object from the output value of the normative model designed for the desired response characteristic, and includes various errors.

An estimated deviation amount Fₑ obtained by estimating the deviation amount F is expressed as in Equation (2), from Equation (1).

$${F}_{e} = \dot{y} - {au}_{e} \qquad ( 2 )$$

Uₑ in Equation (2) is an estimated input obtained by estimating the steering angle u, which is the control input, and is expressed as in Equation (3).

$${u}_{e} = \frac{1}{Ts + 1} u \qquad ( 3 )$$

In Equation (3), T is a time constant.

In this case, the steering angle u is expressed as in Equation (4), as can be seen from FIG. 2.

$$u = \frac{1}{a} \{ \frac{{K}_{i}}{s} e - {K}_{p} y - {F}_{e} \} \qquad ( 4 )$$

In Equation (4), Kₚ is a proportional gain, Kᵢ is an integral gain, and s is a Laplace operator.

The actual yaw rate y is determined from an output yₚ of the control object 102 and a measurement noise d. Therefore, the Ultra-Local Model shown in Equation (1) is a model where the differential of the output of the control object 102, including the measurement noise d, is defined by the steering angle u and the deviation amount F.

The estimated deviation amount Fₑ of Equation (2) is expressed as in Equation (5).

$${F}_{e} = \dot{{y}_{p}} - {au}_{e} + \dot{d} \qquad ( 5 )$$

The estimated deviation amount Fₑ is expressed by using a value obtained by differentiating the actual yaw rate y as shown in Equation (2). Further, the estimated deviation amount Fₑ is expressed by a value obtained by differentiating the measurement noise d as shown in Equation (5). In addition, since the measurement noise d increases when it i differentiated, the estimated deviation amount Fₑ is easily influenced by the measurement noise d. As a result, the steering angle u, which is the control input, also oscillates.

In contrast, in the present embodiment, the estimation part 34 applies a Kalman filter to obtain the estimated deviation amount Fₑ, which will be described in detail below, to achieve the yaw rate control that can suppress the influence of the measurement noise d.

The model conversion part 33 converts the Ultra-Local Model (see Equation (1)) of the control object 102 into the state space model. The conversion of the Ultra-Local Model into the state space model is performed as follows.

Here, it is assumed that a rate of change of the above-described deviation amount F in Equation (1) is minute. In this case, Equation (6) is satisfied.

$$\dot{F} = 0 \qquad ( 6 )$$

Under the above assumption, the model conversion part 33 converts the Ultra-Local Model into the state space model. The state space model after the above conversion is defined by Equation (7) to Equation (12).

$$\dot{x} = Ax + Bu \qquad ( 7 )$$

$$y = Cx \qquad ( 8 )$$

$$x = {[ \begin{matrix}y & F\end{matrix} ]}^{T} \qquad ( 9 )$$

$$A = [ \begin{matrix}0 & 1 \\ 0 & 0\end{matrix} ] \qquad ( 10 )$$

$$B = {[ \begin{matrix}a & 0\end{matrix} ]}^{T} \qquad ( 11 )$$

$$C = [ \begin{matrix}1 & 0\end{matrix} ] \qquad ( 12 )$$

It should be noted that Equation (7) is a state equation, and Equation (8) is an observation equation. Further, x is a state variable, and A, B, and C are coefficients set by a designer, for example.

The estimation part 34 estimates the deviation amount of the output value of the control object from the output value of the normative model in the control model by means of the Kalman filter composed of the state space model obtained by conversion performed by the model conversion part 33. The Kalman filter is a method for estimating a state in the state space model. Here, the Kalman filter is a stationary Kalman filter, and is defined by Equation (13) to Equation (15).

$$\dot{{x}_{e}} = {Ax}_{e} + Bu + L ( y - {y}_{e} ) \qquad ( 13 )$$

$${x}_{e} = {[ \begin{matrix}{y}_{e} & {F}_{e}\end{matrix} ]}^{T} \qquad ( 14 )$$

$$L = {[ \begin{matrix}{L}_{y} & {L}_{F}\end{matrix} ]}^{T} \qquad ( 15 )$$

It should be noted that, in Equation (13), Xe is an estimated value of the state variable x, and ye is an estimated value of the actual yaw rate y. Further, a Kalman gain L can be calculated by using the algebraic Riccati equation as follows.

$$AP + {PA}^{T} - {PC}^{T} {R}^{- 1} CP + Q = 0 \qquad ( 16 )$$

$$L = {PC}^{T} {R}^{- 1} \qquad ( 17 )$$

In Equation (16), P is a solution of the Riccati equation, and Q and R are positive definite matrices, which are design parameters.

The calculation part 35 obtains the control input value on the basis of the estimated deviation amount Fₑ, the proportional gain, and the integral gain. In other words, the calculation part 35 obtains the steering angle u from the estimated deviation amount Fₑ and a PI control law. Specifically, the calculation part 35 obtains the steering angle u of the vehicle, which is the control input, from the following Equations (18) to (22).

$$u = \frac{1}{a} \{ \frac{{K}_{i}}{s} ( r - {y}_{e} ) - {K}_{p} {y}_{e} - {H}_{F} {x}_{e} \} \qquad ( 18 )$$

$${y}_{e} = {H}_{y} {x}_{e} \qquad ( 19 )$$

$$H = {[ \begin{matrix}{H}_{y} & {H}_{F}\end{matrix} ]}^{T} \qquad ( 20 )$$

$${H}_{y} = [ \begin{matrix}1 & 0\end{matrix} ] \qquad ( 21 )$$

$${H}_{F} = [ \begin{matrix}0 & 1\end{matrix} ] \qquad ( 22 )$$

As is clear from Equation (13) to Equation (15), application of the Kalman filter eliminates the need to differentiate the actual yaw rate y when the estimated deviation amount Fₑ is estimated. Thus, the estimation part 34 can estimate the estimated deviation amount Fₑ with the influence of the measurement noise d included in the actual yaw rate y being suppressed. As a result, the steering angle u, expressed in Equation (18), can be prevented from being oscillated due to the increase in the measurement noise d.

The estimation part 34 requires parameter adjustment when the estimation part 34 uses the Kalman filter. Measures to directly adjust the Kalman gain L of the Kalman filter could be considered, but direct adjustment of the Kalman gain L may lead to system instability. In order to solve the above-mentioned problem, the present embodiment adopts a measure of automatically adjusting the parameters Q and R, which set the Kalman gain L, instead of directly adjusting the Kalman gain L. The estimation part 34 estimates the estimated deviation amount Fₑ by using the Kalman filter that is set by the parameters Q and R adjusted by the adjustment part 36. This eliminates the need to adjust the parameters of the Kalman filter by trial and error.

The adjustment part 36 adjusts the parameters Q and R for setting the Kalman gain L of the Kalman filter. Specifically, the adjustment part 36 first estimates a function having i) the parameters Q and R as an input and ii) an evaluation value of an evaluation function defined by the target value (target yaw rate r), the control input value (steering angle u), and the output value (actual yaw rate y) as an output. The above function is a function obtained by using the known Gaussian Process Regression.

The adjustment part 36 adjusts the parameters Q and R by obtaining the minimum value of the estimated function. Specifically, the adjustment part 36 adjusts the parameters Q and R by performing the Bayesian optimization. The Bayesian optimization is a method of estimating the global optimal solution of said function with a small number of trials, while learning an unknown function from data by using the Gaussian Process Regression. In the Bayesian optimization, a function called an acquisition function is used to calculate an optimal input, in the estimation of the global optimal solution, for the function obtained by using the Gaussian Process Regression. This allows the parameters Q and R for designing the Kalman filter to be optimized with a small number of trials. Further, use of the Bayesian optimization allows iteration at a higher speed compared to when other methods are used, and therefore it is easier for the parameters Q and R to be adjusted in a short time.

The adjustment part 36 may adjust the parameters Q and R by constraining the differential of the control input value to be a predetermined value or less. For example, the adjustment part 36 adjusts the parameters Q and R by constraining a speed of the steering angle u to be a predetermined value or less. The predetermined value is a value set by the designer. By adjusting the parameters Q and R under certain constraints, they can be adjusted so as to be more optimal parameters.

The adjustment part 36 obtains the parameters Q and R using the following equations.

$${J}_{w} ( θ ) = \frac{1}{T} {\int }_{0}^{T} {( y ( t , θ ) - {T}_{d} r ( t ) )}^{2} dt + {wP}_{c} ( u ) \qquad ( 23 )$$

$${P}_{c} ( u ) = max \{ 0 , g ( u ) \} \qquad ( 24 )$$

$$g ( u ) = \vert \dot{u} \vert - {u}_{vmax} \leq 0 \qquad ( 25 )$$

It should be noted that, in Equation (23), θ denotes the parameters Q and R, and the parameters Q and R are obtained by obtaining θ. The first term on the right-hand side of Equation (23) shows the square of the difference between an actual response and a target response, and the second term shows a penalty term. Ta is a response desired by the designer, Pc (u) is a penalty function, and w is the weight. |\dot{u}| in Equation (25) denotes the speed of the steering angle. uᵥₘₐₓ is a value set by the designer, and is 1 or 0.1 as an example.

The penalty function method, which uses the penalty function, is a method of solving a constrained optimization problem by converting it into an unconstrained optimization problem. The penalty function method iterates the unconstrained optimization of the penalty function, defined by adding a penalty term (a second term on the right-hand side of Equation (24)) for not satisfying the constraint to an objective function (a first term on the right-hand side of Equation (24)), while increasing the weight of the penalty term.

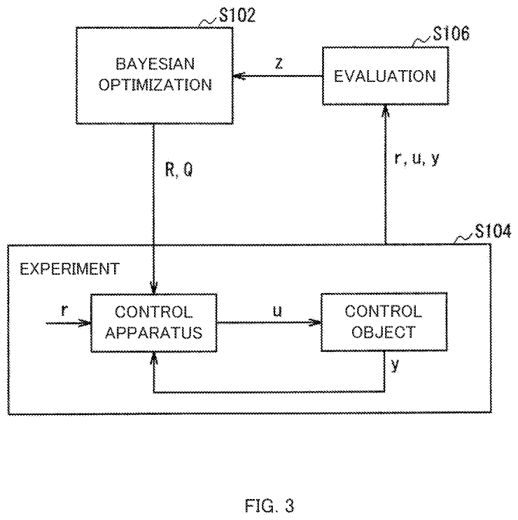

In the present embodiment, the adjustment part 36 performs the process shown in FIG. 3 to automatically adjust the parameters Q and R. FIG. 3 illustrates a flow of automatic adjustment of the parameters Q and R. The adjustment part 36 optimizes the parameters Q and R by iterating the process shown in FIG. 3 (steps $102 to $106).

First, the adjustment part 36 performs the above-described Bayesian optimization (step S102). That is, the adjustment part 36 estimates a function having i) the parameters Q and R as inputs and ii) the evaluation value of the evaluation function defined by the target value, the control input value, and the output value as outputs, and obtains the minimum value of said function to obtain optimized parameters Q and R.

Next, the parameters Q and R obtained in step S102 are inputted to the Kalman filter to perform an experiment of the PI control (step S104). The control apparatus 4 performs yaw rate PI control by using the Kalman filter in which the parameters Q and R have been optimized.

Next, the adjustment part 36 evaluates the PI control by using the data acquired from the result of the experiment in step S104 (step S106). For example, the adjustment part 36 evaluates followability of the steering and a noise level. Data to be acquired includes a target value r, a control input value u, and an output value y, and is acquired by the data acquisition part 32. The adjustment part 36 obtains an evaluation value z of the evaluation function of the above-described Equation (23).

Then, the adjustment part 36 returns to step S102, and performs the Bayesian optimization by using the evaluation value z obtained in step S106 (S102). That is, the adjustment part 36 obtains the evaluation values of the target value, the control input value, and the output value when the PI control is performed by inputting the parameters Q and R to the Kalman filter, and estimates the function again. Then, the adjustment part 36 obtains the minimum value of the estimated function, thereby optimizing the parameters Q and R again. The adjustment part 36 iterates the steps S102 to S106 a predetermined number of times. Thus, the control model becomes accurate (in other words, the model error is compensated for), and more optimal parameters Q and R can be obtained.

### Effects of the Present Embodiment

The control apparatus 4 of the embodiment described above includes i) the estimation part 34 that estimates the deviation amount Fₑ in the control model, in which the differential of the output value of the control object 102 including the measurement noise is defined by the control input value and the amount of deviation of the output value of the control object from the output value of the normative model, by means of the Kalman filter composed of the state space model, ii) the calculation part 35 that obtains the control input value on the basis of the estimated deviation amount Fₑ, the proportional gain, and the integral gain, and iii) the adjustment part 36 that adjusts the parameters R and Q for setting the Kalman gain L of the Kalman filter.

When the estimation part 34 estimates the estimated deviation amount Fₑ by applying the Kalman filter, since the Kalman filter does not differentiate the actual yaw rate y (output of the control object), the influence of the measurement noise d included in the actual yaw rate y can be suppressed. Further, by adjusting the parameters R and Q instead of directly adjusting the Kalmen gain L, the adjustment part 36 can optimize the parameters for designing the Kalman filter while suppressing the system from becoming unstable.

The present disclosure is explained on the basis of the exemplary embodiments. The technical scope of the present disclosure is not limited to the scope explained in the above embodiments and it is possible to make various changes and modifications within the scope of the disclosure. For example, all or part the apparatus can be configured with any unit which is functionally or physically dispersed or integrated. Further, new exemplary embodiments generated by arbitrary combinations of them are included in the exemplary embodiments of the present disclosure. Further, effects of the new exemplary embodiments brought by the combinations also have the effects of the original exemplary embodiments.

1. A control apparatus for PI-controlling a control input value to a control object on the basis of a difference between a target value to the control object and an output value from the control object, the control apparatus comprising:
an estimation part that estimates an amount of deviation in a control model, in which a differential of an output value of the control object including measurement noise is defined by i) the control input value and ii) an amount of deviation of the output value of the control object from an output value of a normative model, by means of a Kalman filter composed of a state space model;
a calculation part that obtains the control input value on the basis of the estimated amount of deviation, a proportional gain, and an integral gain; and
an adjustment part that adjusts a parameter for setting a Kalman gain of the Kalman filter.

2. The control apparatus according to claim 1, wherein
the adjustment part estimates a function having i) the parameter as an input and ii) an evaluation value of an evaluation function defined by the target value, the control input value, and the output value as an output, and
the adjustment part adjusts the parameter by obtaining the minimum value of the estimated function.

3. The control apparatus according to claim 2, wherein
the adjustment part obtains evaluation values of the target value, the control input value, and the output value when the parameters are inputted to the Kalman filter to perform PI control, and estimates the function again.

4. The control apparatus according to claim 2, wherein
the adjustment part iterates i) an estimation of the function having the parameter after adjustment as an input and ii) a calculation of a minimum value of the estimated function, a predetermined number of times, and
the estimation part estimates the amount of deviation by means of the Kalman filter set by the parameters obtained by the predetermined number of iterations.

5. The control apparatus according to claim 2, wherein
the adjustment part adjusts the parameters by constraining a differential of the control input value to be a predetermined value or less.

6. The control apparatus according to claim 1, wherein
the target value is a target yaw rate of a vehicle,
a control input to the control object is a steering angle of the vehicle, and
an output from the control object is an actual yaw rate of the vehicle.

7. The control apparatus according to claim 1, further comprising:
a model conversion part that converts the control model into the state space model, wherein
the estimation part estimates the amount of deviation by means of the Kalman filter of the state space model resulting from the conversion by the model conversion part.

8. A control method, executed by a processor, for PI-controlling a control input value to a control object on the basis of a difference between a target value to the control object and an output value from the control object, the method comprising the steps of:
estimating an amount of deviation in a control model, in which a differential of an output value of the control object including measurement noise is defined by i) the control input value and ii) a deviation amount of the output value of the control object from an output value of a normative model, by means of a Kalman filter composed of a state space model;
obtaining the control input value on the basis of the estimated amount of deviation, a proportional gain, and an integral gain; and
adjusting a parameter for setting a Kalman gain of the Kalman filter.
